(19) United States
(12) Patent Application Publication
(10) Pub. No.: US 2014/0230987 A1
(43) Pub. Date: Aug. 21, 2014

(54) TIRE HAVING AN OFFSET BODY PLY CONSTRUCTION

(71) Applicant: BRIDGESTONE AMERICAS TIRE OPERATIONS, LLC, Nashville, TN (US)

(72) Inventors: John R. Sabistina, Cuyahoga Falls, OH (US); Kathleen A. Clemmer, Akron, OH (US); Kent D. Weatherwax, Akron, OH (US); Andrew D. Anderson, Copley, OH (US); Elizabeth M. Beutler, Munroe Falls, OH (US); Juan D. Leyva, Stow, OH (US); John I. Stuckey, Louisville, OH (US)

(73) Assignee: BRIDGESTONE AMERICAS TIRE OPERATIONS, LLC, Nashville, TN (US)

(21) Appl. No.: 13/773,193

(22) Filed: Feb. 21, 2013

(51) Int. Cl. B60C 9/18

(52) U.S. Cl. CPC B60C 9/18
USPC 152/526

(57) ABSTRACT

Various embodiments of a tire having an offset body ply construction are disclosed.

### BACKGROUND

In the construction of a tire, one of the many key elements is the body ply. The body ply, which typically comprises reinforcement cord and rubber skim, wraps around the bead wire bundle (creating a “turnup” portion), passes radially across the tire, and wraps around the bead bundle on the opposite side (creating another “turnup” portion). The body ply provides strength to contain the air pressure within the tire and provides for sidewall impact resistance.

In a tire comprising a plurality of carcass plies, it is often desirable to maintain similar height in the turnup portions of each carcass ply, on each side of the tire, so that the tire will have similar reinforcement and stiffness on each side. That is, a first carcass ply may have a first turnup height, while a second carcass ply may have a second turnup height. Each carcass ply typically has a similar height in its turnup portions on each side of the tire because the turnup height plays a direct role in the amount of reinforcement a carcass ply provides to a tire. A mismatch of turnup height in a carcass ply may result in one side of the tire being stiffer than the other side of the tire, thus leading to undesirable aligning torque in the tire.

Accordingly, the carcass plies typically comprise different widths (e.g., the carcass ply implementing the higher turnup heights will be wider than the carcass ply with the lower turnup heights). As a result of these different carcass ply widths, the actual building of such a tire having a plurality of carcass plies may be inefficient and overly complicated.

What is needed is a tire comprising a plurality of offset carcass plies of substantially the same width, which maintain similar reinforcement and stiffness on each side of the tire, while eliminating the need for carcass plies of varying widths in the building of the tire.

### SUMMARY

In one embodiment, a pneumatic tire is provided, the pneumatic tire comprising: a tread portion; a first bead portion oriented on a first side of the tire; a first sidewall oriented on the first side of the tire; a second bead portion oriented on a second side of the tire; a second sidewall oriented on the second side of the tire; a first offset body ply extending about the first bead portion, along the first sidewall, and terminating at a point within the tread portion; and a second offset body ply extending about the second bead portion, along the second sidewall, and terminating at a point within the tread portion.

In another embodiment, a pneumatic tire is provided, the pneumatic tire comprising: a belt comprising a first belt edge and a second belt edge; a first bead portion oriented on a first side of the tire; a first sidewall oriented on the first side of the tire; a second bead portion oriented on a second side of the tire; a second sidewall oriented on the second side of the tire; a first offset body ply extending about the first bead portion, along the first sidewall, and terminating at a point transversely between the first belt edge and the second side of the tire; a second offset body ply extending about the second bead portion, along the second sidewall, and terminating at a point transversely between the second belt edge and the first side of the tire.

In another embodiment, a pneumatic tire is provided, the pneumatic tire comprising: a tread portion; a first bead portion oriented on a first side of the tire; a first sidewall oriented on the first side of the tire; a second bead portion oriented on a second side of the tire; a second sidewall oriented on the second side of the tire; a first offset body ply extending about the first bead portion, along the first sidewall, through the tread portion, along the second sidewall, and terminating at a first termination point, a second offset body ply extending about the second bead portion, along the second sidewall, through the tread portion, along the first sidewall, and terminating at a second termination point, wherein the first termination point is at a height T3, and wherein the second termination point is at a height T4.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a cross-sectional view of an example arrangement of a tire having an offset body ply construction.

FIG. 2 illustrates a cross-sectional view of an example arrangement of a tire having an offset body ply construction.

FIG. 3 illustrates a cross-sectional view of a prior art tire construction.

### DETAILED DESCRIPTION

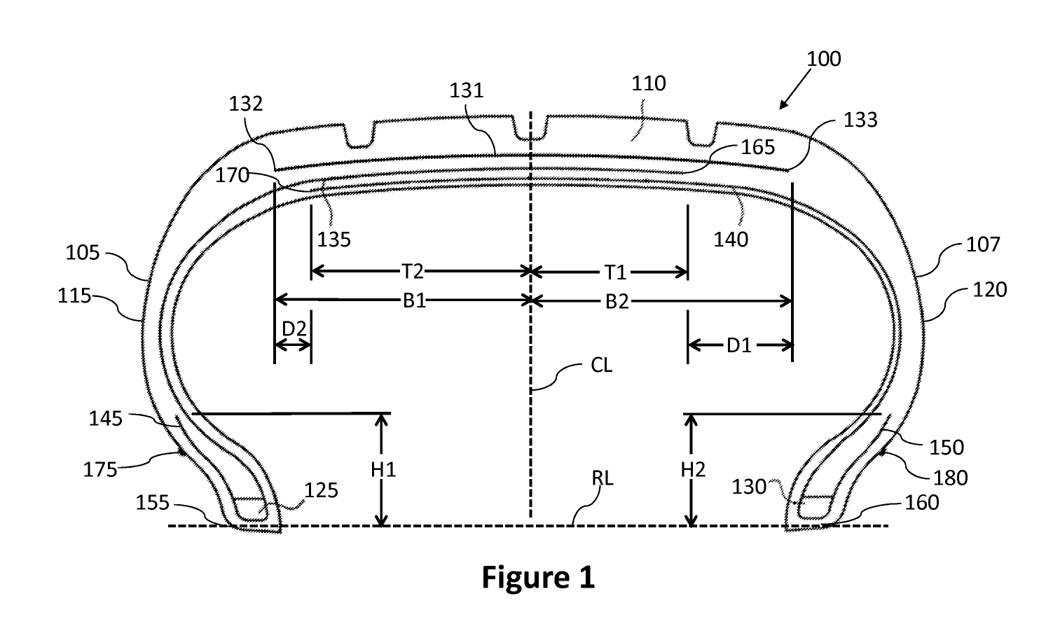

FIG. 1 illustrates a cross-sectional view of an example arrangement of a tire 100 having an offset body ply construction. Tire 100 may comprise a first sidewall 105, a second sidewall 107, a tread portion 110, a first side 115, and a second side 120. Tire 100 may additionally comprise a first bead portion 125 and a second bead portion 130. In one embodiment, tire 100 comprises a belt 131. Belt 131 may comprise a first end 132 and a second end 133.

Tire 100 may comprise a pneumatic tire. In one embodiment, tire 100 is a pneumatic tire designed for application to a vehicle. In another embodiment, tire 100 is a pneumatic tire designed for application to a road vehicle. In one embodiment, tire 100 is a non-directional tire, wherein tire 100 is configured to be mounted on a vehicle without a specified forward rolling direction. In another embodiment, tire 100 is a uni-directional tire, wherein tire 100 is configured to be mounted on a vehicle with a specified forward rolling direction.

In one embodiment, tire 100 comprises a plurality of body plies. In one embodiment, tire 100 comprises a first offset body ply 135 and a second offset body ply 140. In one embodiment, the reinforcement cord is a fiber reinforcement cord. In another embodiment, the reinforcement cord can be any of a variety of materials, including for example, polyester, rayon, nylon, aramid, and polyethylene naphthalate (PEN). In one embodiment, the rubber skim is any of a variety of rubber materials, having any of a variety of common formulations, densities, and other properties for use in tires. First offset body ply 135 and second offset body ply 140 may comprise a reinforcement cord and rubber skim. In one embodiment, first offset body ply 135 and second offset body ply 140 are comprised of different materials. In another embodiment, first offset body ply 135 and second offset body ply 140 are selected to tune stiffness and/or durability of tire 100.

First offset body ply 135 may extend about first bead portion 125, along first sidewall 105 in first side 115, and terminate at a point within tread portion 110 of tire 100. First offset body ply 135 may comprise a first offset body ply turnup portion 145 defined by the portion of first offset body ply 135 extending about first bead portion 125.

Second offset body ply 140 may extend about second bead portion 130, along second sidewall 107 in second side 120, and terminate at a point within tread portion 110 of tire 100. Second offset body ply 140 may comprise a second offset body ply turnup portion 150 defined by the portion of second offset body ply 140 extending about second bead portion 130.

Tire 100 may comprise a first side heel point 155 extending circumferentially about first side 115 of tire 100. Tire 100 may comprise a second side heel point 160 extending circumferentially about second side 120 of tire 100. A reference line RL extending between first heel point 155 and second heel point 160 may be used as a reference for radial measurements in tire 100. Reference line RL may be oriented radially inwardly of first bead portion 125 and second bead portion 130. Radial measurements in tire 100 extending radially outward of reference line RL shall have a positive number, while radial measurements radially inward of reference line RL shall have a negative number.

In one embodiment, first offset body ply 135 comprises a first offset body ply turnup portion 145 extending to a height H1 relative to reference line RL. In one embodiment, second offset body ply 140 comprises a second offset body ply turnup portion 150 extending to a height H2 relative to reference line RL. In one embodiment, height H1 is substantially equal to height H2. In another embodiment, height H1 is greater than height H2. In another embodiment, height H1 is less than height H2.

In one embodiment, tire 100 comprises a centerline CL oriented at the laterally central point within tire 100. Centerline CL may correspond with the centerline of a rim.

Belt 131 may comprise a first belt edge 132 and a second belt edge 133. First belt edge 132 may extend to a distance B1 from centerline CL. Second belt edge 133 may extend to a distance B2 from centerline CL.

First offset body ply 135 may comprise a first termination point 165 defined by the point at which first offset body ply 135 terminates in tread portion 110. Second offset body ply 140 may comprise a second termination point 170 defined by the point at which second offset body ply 140 terminates in tread portion 110.

In one embodiment, first termination point 165 extends to a distance T1 from centerline CL. In another embodiment, second termination point 170 extends to a distance T2 from centerline CL.

In one embodiment, first offset body ply 135 comprises a first termination point 165 oriented transversely between first belt edge 132 and second belt edge 133. In another embodiment, second offset body ply 140 comprises a second termination point 170 oriented transversely between first belt edge 132 and second belt edge 133. In another embodiment, first offset body ply 135 comprises a first termination point 165 oriented transversely between first belt edge 132 and second side 120 of tire 100, radially outwardly of second bead portion 130. In another embodiment, second offset body ply 140 comprises a second termination point 170 oriented transversely between second belt edge 133 and first side 115 of tire 100, radially outwardly of first bead portion 125. In one embodiment, at least one of first offset body ply 135 and second offset body ply 140 is oriented radially inwardly of belt 131.

In one embodiment, first termination point 165 is offset from second belt edge 133 by a distance D1, which is equal to B2−T1. In one embodiment, distance D1 is between about 0.0 in. and about 5.0 in. In another embodiment, distance D1 is between about 0.5 in. and about 3.0 in. In another embodiment, distance D1 is between about 1.0 in. and about 2.0 in.

In one embodiment, second termination point 170 is offset from first belt edge 132 by a distance D2, which is equal to B1−T2. In one embodiment, distance D2 is between about 0.0 in. and about 5.0 in. In another embodiment, distance D2 is between about 0.5 in. and about 3.0 in. In another embodiment, distance D2 is between about 1.0 in. and about 2.0 in.

In one embodiment, distance D1 is substantially equal to distance D2. In another embodiment, distance D1 is greater than distance D2. In another embodiment, distance D1 is less than distance D2.

In one embodiment, tire 100 comprises two thicknesses of body ply within tread region 110, while comprising one thickness in each of first sidewall 105 and second sidewall 107. As such, tire 100 may be engineered to comprise a specific desired crown stiffness, sidewall stiffness, and weight. In one embodiment, tire 100 comprises appropriate crown stiffness to meet a Department of Transportation tire plunger test. In another embodiment, tire 100 comprises appropriate crown stiffness without excessive sidewall stiffness.

Tire 100 may comprise a first side rim line 175 extending circumferentially about first side 115 of tire 100. Tire 100 may comprise a second side rim line 180 extending circumferentially about second side 120 of tire 100. In one embodiment, tire 100 comprises a first rim line 175 and a second rim line 180, wherein a reference line (not shown) extending between first rim line 175 and second rim line 180 may be used as a reference for radial measurements in tire 100. Such measurements include heights H1 and H2.

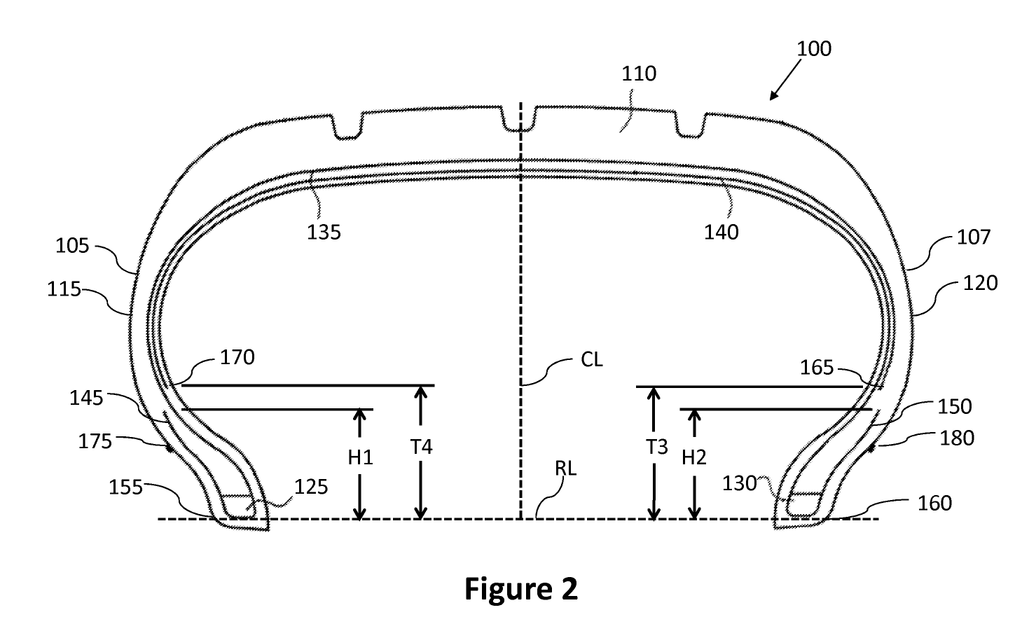

FIG. 2 illustrates a cross-sectional view of an example arrangement of a tire 100 having an offset body ply construction. Tire 100 may comprise a first sidewall 105, a second sidewall 107, a tread portion 110, a first side 115, and a second side 120. Tire 100 may additionally comprise a first bead portion 125 and a second bead portion 130. Tire 100 may comprise a first offset body ply 135 and a second offset body ply 140.

First offset body ply 135 may extend about first bead portion 125, along first sidewall 105 in first side 115, across tread portion 110, along second sidewall 107 in second side 120, and terminate at a point radially outwardly of second bead portion 130. First offset body ply 135 may comprise a first offset body ply turnup portion 145 defined by the portion of first offset body ply 135 extending about first bead portion 125.

Second offset body ply 140 may extend about second bead portion 130, along second sidewall 107 in second side 120, across tread portion 110, along first sidewall 105 in first side 115, and terminate at a point radially outwardly of first bead portion 125. Second offset body ply 140 may comprise a second offset body ply turnup portion 150 defined by the portion of second offset body ply 140 extending about second bead portion 130.

First offset body ply 135 may also comprise a first termination point 155 defined by the point at which first offset body ply 135 terminates in second side 120. In one embodiment, second bead portion 130 comprises a second bead filler (not shown), and first offset body ply 135 terminates at a point radially outwardly of the second bead filler.

Second offset body ply 140 may also comprise a second termination point 160 defined by the point at which second offset body ply 140 terminates in first side 115. In one embodiment, first bead portion 125 comprises a first bead filler (not shown), and second offset body ply 140 terminates at a point radially outwardly of the first bead filler.

In one embodiment, first offset body ply 135 terminates at a first termination point 165. First termination point 165 may be oriented at a height T3 measured from reference line RL. In one embodiment, first termination point 165 is radially outwardly of second bead portion 130. In another embodiment, first termination point 165 is radially outwardly of the second bead filler.

In one embodiment, second offset body ply 140 terminates at a second termination point 170. Second termination point 170 may be oriented at a height T4 measured from reference line RL. In one embodiment, second termination point 170 is radially outwardly of first bead portion 125. In another embodiment, second termination point 170 is radially outwardly of the first bead filler.

In one embodiment, first offset body ply 135 comprises a first offset body ply turnup portion 145 extending to a height H1 relative to reference line RL. In one embodiment, second offset body ply 140 comprises a second offset body ply turnup portion 150 extending to a height H2 relative to reference line RL. In one embodiment, height H1 is substantially equal to height H2. In another embodiment, height H1 is greater than height H2. In another embodiment, height H1 is less than height H2.

In one embodiment, at least one of height T3 and height T4 is greater than at least one of height H1 and height H2. In another embodiment, at least one of height T3 and height T4 is less than at least one of height H1 and height H2. In another embodiment, at least one of height T3 and height T4 is substantially equal to at least one of height H1 and height H2.

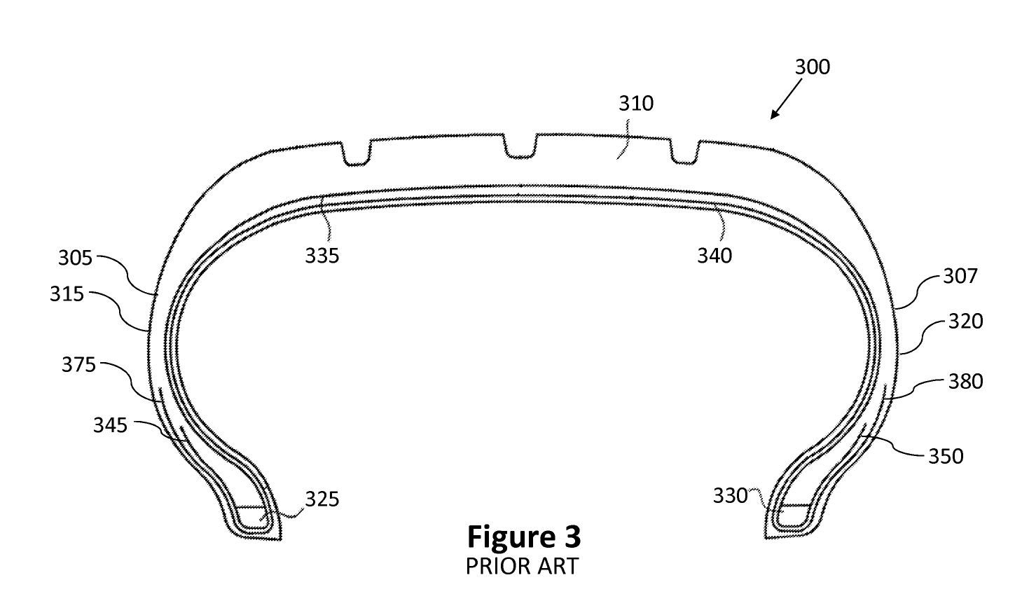

FIG. 3 illustrates a cross-sectional view of a tire 300 having a prior art construction. Tire 300 has a first sidewall 305, a second sidewall 307, a tread portion 310, a first side 315, and a second side 320. Tire 300 may also have a first bead portion 325 and a second bead portion 330.

Tire 300 may have a plurality of body plies. For example, tire 300 may have a first body ply 335 and a second body ply 340. First body ply 335 may extend about first bead portion 325, along first sidewall 305 in first side 315, across tread portion 310, along second sidewall 307 in second side 320, and about second bead portion 330. First body ply 335 may have a first body ply first turnup portion 345 defined by the portion of first body ply 335 extending about first bead portion 325. First body ply 335 may also have a first body ply second turnup portion 350 defined by the portion of first body ply 335 extending about second bead portion 330.

Second body ply 340 may extend about second bead portion 330 along second sidewall 307 in second side 320, across tread portion 310, along first sidewall 305 in first side 315, and about first bead portion 325. Second body ply 340 may have a second body ply first turnup portion 375 defined by the portion of second body ply 340 extending about first bead portion 325. Second body ply 340 may also have a second body ply second turnup portion 380 defined by the portion of second body ply 340 extending about second bead portion 330.

As illustrated in FIG. 3, in tire 300, first body turnup portion 345 and first body ply second turnup portion 350 are substantially the same height, which height is less than the height of second body ply first turnup portion 375 and second body ply second turnup portion 380 (which have substantially the same height). As a result of the prior art arrangement, first body ply 335 has a greater width than second body ply 340. Thus, prior art tire 300 requires that two separate widths of body plies be prepared in the construction of tire 300.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±0.25 inches. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A pneumatic tire, comprising:
a tread portion;
a first bead portion oriented on a first side of the tire;
a first sidewall oriented on the first side of the tire;
a second bead portion oriented on a second side of the tire;
a second sidewall oriented on the second side of the tire;
a first offset body ply extending about the first bead portion, along the first sidewall, and terminating at a point within the tread portion; and
a second offset body ply extending about the second bead portion, along the second sidewall, and terminating at a point within the tread portion.

2. The pneumatic tire of claim 1, wherein the tread portion comprises a belt having a first belt edge and a second belt edge, and wherein the first offset body ply terminates at a point transversely between the first belt edge and the second belt edge.

3. The pneumatic tire of claim 1, wherein the tread portion comprises a belt having a first belt edge and a second belt edge, and wherein the second offset body ply terminates at a point transversely between the first belt edge and the second belt edge.

4. The pneumatic tire of claim 1, wherein the tread portion comprises a belt, and at least one of the first offset body ply and the second offset body ply is oriented radially inwardly of the belt.

5. The pneumatic tire of claim 1,
wherein the first offset body ply terminates at a first termination point,
and wherein the tread portion comprises a belt having a first belt edge and a second belt edge;
and wherein the first termination point is displaced from the second belt edge by a distance D1;
and wherein the distance D1 is up to about 5.0 in.

6. The pneumatic tire of claim 1,
wherein the second offset body ply terminates at a second termination point,
and wherein the tread portion comprises a belt having a first belt edge and a second belt edge;
and wherein the second termination point is displaced from the first belt edge by a distance D2;
and wherein the distance D2 is up to about 5.0 in.

7. The pneumatic tire of claim 1, wherein the first offset body ply comprises a first turnup portion extending to a height H1.

8. The pneumatic tire of claim 1, wherein the second offset body ply comprises a second turnup portion extending to a height H2.

9. A pneumatic tire, comprising:
a belt comprising a first belt edge and a second belt edge;
a first bead portion oriented on a first side of the tire;
a first sidewall oriented on the first side of the tire;
a second bead portion oriented on a second side of the tire;
a second sidewall oriented on the second side of the tire;
a first offset body ply extending about the first bead portion, along the first sidewall, and terminating at a point transversely between the first belt edge and the second side of the tire, radially outwardly of the second bead portion;
a second offset body ply extending about the second bead portion, along the second sidewall, and terminating at a point transversely between the second belt edge and the first side of the tire, radially outwardly of the first bead portion.

10. The pneumatic tire of claim 9,
wherein the first offset body ply terminates at a first termination point,
and wherein the first termination point is displaced from the second belt edge by a distance D1;
and wherein the distance D1 is up to about 5.0 in.

11. The pneumatic tire of claim 1,
wherein the second offset body ply terminates at a second termination point,
and wherein the second termination point is displaced from the first belt edge by a distance D2;
and wherein the distance D2 is up to about 5.0 in.

12. The pneumatic tire of claim 9, wherein at least one of the first offset body ply and the second offset body ply are oriented radially inwardly of the belt.

13. The pneumatic tire of claim 9, wherein the first offset body ply comprises a first turnup portion extending to a height H1.

14. The pneumatic tire of claim 9, wherein the second offset body ply comprises a second turnup portion extending to a height H2.

15. The pneumatic tire of claim 9,
wherein the first offset body ply terminates at a first termination point, wherein the first termination point is at a height T3,
and wherein the second offset body ply terminates at a second termination point, and wherein the second termination point is at a height T4,
and wherein at least one of the first termination point and the second termination point is oriented radially outwardly of the first bead portion and the second bead portion.

16. A pneumatic tire, comprising:
a tread portion;
a first bead portion oriented on a first side of the tire;
a first sidewall oriented on the first side of the tire;
a second bead portion oriented on a second side of the tire;
a second sidewall oriented on the second side of the tire;
a first offset body ply extending about the first bead portion, along the first sidewall, through the tread portion, along the second sidewall, and terminating at a first termination point,
a second offset body ply extending about the second bead portion, along the second sidewall, through the tread portion, along the first sidewall, and terminating at a second termination point,
wherein the first termination point is at a height T3, and
wherein the second termination point is at a height T4.

17. The pneumatic tire of claim 16, wherein the first termination point is oriented radially outwardly of the first bead portion.

18. The pneumatic tire of claim 16, wherein the second termination point is oriented radially outwardly of the second bead portion.

19. The pneumatic tire of claim 16, wherein the first bead portion comprises a first bead filler, and wherein the first termination point is oriented radially outwardly of the first bead filler.

20. The pneumatic tire of claim 16, wherein the second bead portion comprises a second bead filler, and wherein the second termination point is oriented radially outwardly of the second bead filler.
